(19) United States
(12) Patent Application Publication
(10) Pub. No.: US 2013/0297482 A1
(43) Pub. Date: Nov. 7, 2013

(54) System and Method for Selectively Directing Financial Transactions to Designated Parties

(71) Applicant: MIAMI INTERNATIONAL SECURITIES EXCHANGE, LLC, Princeton, NJ (US)

(72) Inventors: Shelly Brown, West Windsor, NJ (US); Richard Ross, Gladwyne, PA (US)

(73) Assignee: Miami International Securities Exchange, LLC, Princeton, NJ (US)

(21) Appl. No.: 13/874,949

(22) Filed: May 1, 2013

Related U.S. Application Data
(60) Provisional application No. 61/641,536, filed on May 2, 2012.

(51) Int. Cl. G06Q 40/04

(52) U.S. Cl. CPC G06Q 40/04
USPC 705/37

(57) ABSTRACT

A computerized trading platform for performing Enhanced Allocation of contracts from an order to Lead Market Makers depending on the number of contracts to be traded at a national best bid offer (NBBO). After all customer orders have been processed, lots of a small size order (SSO) will be preferentially directed to a Lead Market Maker without sharing. For each incoming order that is not a small size, if the Lead Market Maker is quoting at the NBBO, its participation entitlement is equal to the greater of (i) the proportion of the size of the LMM's quote to the total quote size at the LE-BBO, (ii) sixty percent (60%) of the contracts to be allocated if there is only one (1) other Market Maker quotation at the LE-BBO and (iii) forty percent (40%) of the contracts if there are two (2) or more other Market Maker quotations at the LE-BBO. For purposes of allocation, all Market Maker Priority interest at a certain price level shall be aggregated. Lead Market Makers may additionally be entitled to at least the small size order.

### CROSS-REFERENCE TO RELATED APPLICATIONS

This application claims the benefit under 35 USC 119(e) and is a non-provisional of U.S. Provisional Appln. No. 61/641,536, filed May 2, 2012, the entire contents of which are hereby incorporated by reference.

### FIELD OF INVENTION

The present invention is directed to a system and method for selectively directing financial transactions to designated parties in an electronic trading system, and in one embodiment to an electronic trading platform for trading options contracts in which an established number of contracts, the Enhanced Allocation, from certain types of orders is directed to at least one Lead Market Maker for the kind of contract being traded.

### DISCUSSION OF THE BACKGROUND

A number of different electronic trading platforms enable buyers and sellers of various financial instruments (e.g., options and equities) to be matched according to a set of agreed upon trading rules. The exchanges upon which the trades are made may include rules on how trades are to be allocated under various conditions. For example, when a number of buyers all bid at the same price, the rules describe how many contracts each of the various buyers are allocated if there is an insufficient number of corresponding sell contracts.

The rules on how many contracts in an order are allocated to each buyer may also depend on the type of buyers that are involved. For example, in addition to customers, there may also be non-customer (e.g., institutional investors and market makers). Certain kinds of market makers may receive directed orders and the associated Enhanced Allocation under certain circumstances in exchange for accepting the additional responsibilities of a particular level of market maker (e.g., quoting and participation requirements) and for meeting other financial requirements (e.g., having at least a threshold amount of capital).

### BRIEF DESCRIPTION OF THE DRAWINGS

The following description, given with respect to the attached drawings, may be better understood with reference to the non-limiting examples of the drawings, wherein:

FIG. 1 is a block diagram of an electronic trading platform for providing trading among a number of trading participants (e.g., customers, Market Makers and Lead Market Makers);

FIG. 2 is a flowchart showing trade allotments according to a first aspect of an exemplary trading platform; and

FIG. 3 is a flowchart showing trade allotments according to a second aspect of an exemplary trading platform.

### DISCUSSION OF THE PREFERRED EMBODIMENTS

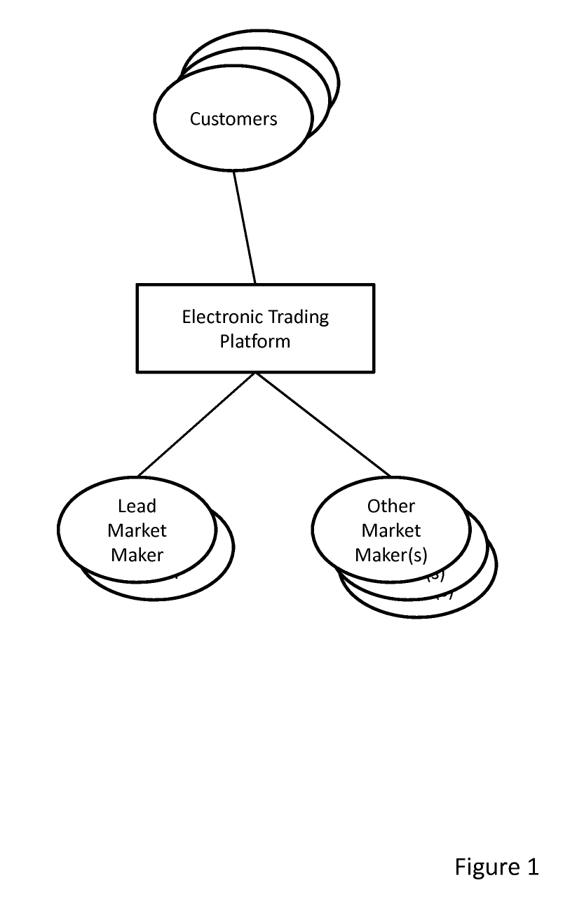

Turning to FIG. 1, an electronic trading platform is illustrated that facilitates trades between a number of possible trading parties. A trading platform can be implemented as a series of interconnected computers for communicating between the trading partners and a centralized computer system acting as the Exchange. The centralized computer system is preferably at least one parallel processing computer that records the interactions between the trading parties and matches bids and offers as described more fully herein. The computer system includes at least one computer processor, digital computer memory and non-volatile storage devices (e.g., hard disk drive, disk array, and/or EEPROM/Flash memory arrays). The computer system further includes computer code stored in the digital computer memory (potentially having been read from the non-volatile storage devices) for controlling the computer processor to perform steps defined by the computer code. The computer code controls the computer system to perform the processing described herein.

The electronic trading platform can perform trading of one or more types of financial instruments (e.g., equities or options). In one embodiment of the trading platform, Lead Market Makers (LMMs) are assigned on a per-financial instrument basis, and the same LMMs may be assigned to multiple financial instruments. LMMs have certain quoting, participation and financial obligations. For example, an LMM may be required to provide quotes for 90% of an assigned series or financial instrument all day. The LMM may also be required to participate in the opening, and to have substantial capital (e.g., $1.5 million in capital).

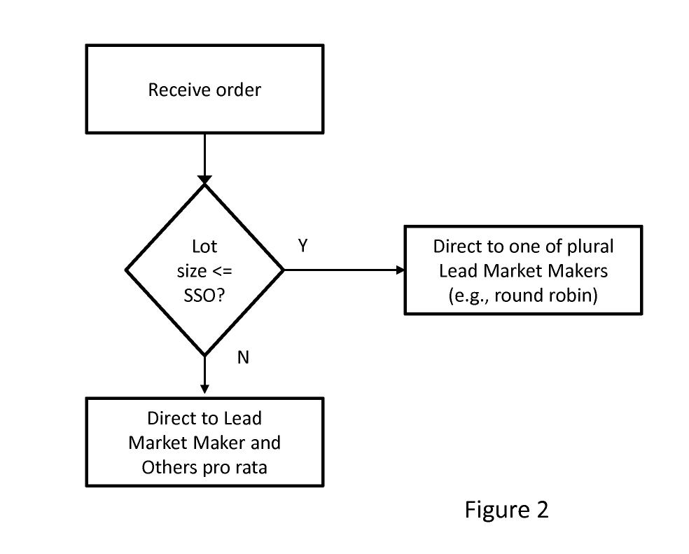

In exchange for the obligations imposed on LMMs, LMMs may be entitled to receive a marketing fee and/or to receive an Enhanced Allocation (e.g., resulting from Directed Orders), as described in greater detail in the embodiments described herein. In general, an LMM may receive directed orders (e.g., after all customer orders have been processed or only on the size of the order upon receipt). In one embodiment, the LMM that receives the Enhanced Allocation from a Directed Order is a first LMM of a plurality of LMMs, wherein the first LMM is specified in the order and assuming that the first LMM is quoting at the national best bid or offer (NBBO) at the time of receipt of the order. However, if the order is not directed or the first LMM to which the order is directed is not quoting at the NBBO at the time of receipt of the order, then the LMM that will receive the Enhanced Allocation is a Primary LMM (PLMM) for that type of contract, assuming that the PLMM is quoting at the NBBO at the time of receipt of the order. (If the PLMM is not quoting at the NBBO either, then there is no Enhanced Allocation and the order is allocated on a strictly pro-rata basis.) In another embodiment, if the order is not directed or the first LMM to which the order is directed is not quoting at the NBBO at the time of receipt of the order, then the LMM that will receive the Enhanced Allocation is chosen accordingly to a specified technique (e.g., round robin or randomly) from LMMs for that kind of contract that were quoting at the NBBO at the time the order was received, as shown in FIG. 2. In yet another embodiment, there may only be a single LMM for the kind of contract being quoted.

In a first embodiment, lots of a small size order (SSO) (or less) will be preferentially allocated to an LMM using one of the allocation techniques described above. The SSO may be defined by the trading platform and may be consistent for all kinds of contracts or may vary from contract-type to contract-type, as long as all participants are aware of the SSO threshold. In one embodiment, the SSO threshold is five (5) or fewer contracts. In order to address the possibility that the SSO direction mechanism could become overly biasing, it is possible to maintain the SSO threshold at a level that attempts to avoid the SSOs executed by the LMM from accounting for more than 40% of the volume executed on the Exchange (excluding volume resulting from the execution of orders in the Crossing and Auction Mechanism.

For each incoming order that is larger than the SSO threshold, if the LMM is quoting at the NBBO, the LMM's Enhanced Allocation in a first embodiment is equal to the greater of (i) the proportion of the size of the LMM's quote to the total quote size at the LE-BBO (i.e., local exchange Best Bid Offer), or (ii) sixty percent (60%) of the contracts to be allocated if there is only one other Market Maker quotation at the LE-BBO and (iii) forty percent (40%) of the contracts if there are at least two Market Maker quotations at the LE-BBO. For purposes of allocation, all Market Maker Priority interest at a certain price level shall be aggregated.

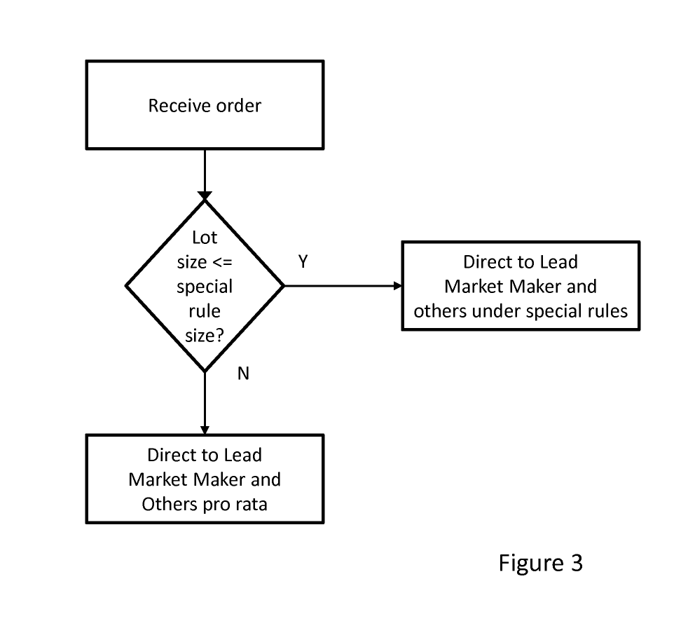

Because the rule of the first embodiment can result in an allocation to the LMM of less than the order size the LMM would have received had the order been an SSO, in a second embodiment as shown in FIG. 3, the allocation rule is modified to be: the greater of (i) the size that the LMM would have gotten had the order been an SSO, (ii) the proportion of the size of LMM's quote to the total quote size at the LE-BBO, (iii) sixty percent (60%) of the contracts to be allocated if there is only one other Market Maker quotation at the LE-BBO and (iv) forty percent (40%) of the contracts if there are at least two other Market Maker quotations at the LE-BBO. For purposes of allocation, all Market Maker interest at a certain price level (including quotes and orders) shall be aggregated. In such a configuration, it is therefore possible to direct to an LMM an Enhanced Allocation guarantying a minimum number of contracts (e.g., the SSO size of five as described in the embodiment above).

The effect of such a configuration would be seen in orders slightly larger than the SSO when, for example, an order of size 6 came in and there was only one other Market Maker quoting at the NBBO. Under the first embodiment, the LMM would receive 60% of the 6 contracts or floor (6*.06)=floor (3.6)=3 contracts, where floor ( )is a function that rounds down to the next integer. Under the second embodiment, because the SSO threshold is 5, the LMM instead gets an Enhanced Allocation of 5 contracts out of the 6 total contracts in the order, thereby resulting in a greater directed amount to the LMM.

In an alternate embodiment, the SSO is increased or decreased to affect the number of directed orders (or the percentage of orders that are traded through Directed Orders), and the size of the SSO may be varied on a contract-type-by-contract-type basis. In one configuration, the SSO is set to ten (10) or twenty (20).

While certain configurations of structures have been illustrated for the purposes of presenting the basic structures of the present invention, one of ordinary skill in the art will appreciate that other variations are possible which would still fall within the scope of the appended claims.

1. A computerized trading platform, comprising:
a computer processor;
digital computer memory including computer code stored therein, the computer code controlling the computer processor to perform the steps of:
receiving an order for a transaction;
determining if a size of the order is at most a small size order;
allocating to a Lead Market Maker (LMM) all of the order as an Enhanced Allocation if the size of the order is at most the small size order (SSO) threshold and the LMM is quoting at a national best bid or offer (NBBO);
allocating to the LMM the Enhanced Allocation of the order if the size of the order is above the SSO threshold and the LMM is quoting at the NBBO, wherein the LMM portion is equal to the greater of (i) the proportion of the size of the quote of the LMM to the total quote size at the LE-BBO, (ii) sixty percent (60%) of the order if there is only one other Market Maker quotation at the LE-BBO, and (iii) forty percent (40%) of the order if there are at least two other Market Makers quotations at the LE-BBO, wherein the LMM to which the Enhanced Allocation is allocated is chosen utilizing a round robin allocation from all the LMMs quoting at NBBO at the time the order was received.

2. The computerized trading platform as claimed in claim 1, wherein the small size order is 5 contracts.

3. The computerized trading platform as claimed in claim 1, wherein the order is a remaining portion of an original order after first allocating to Customers at the LE-BBO their portion of the original order.

4. The computerized trading platform as claimed in claim 1, wherein the order is an original order before first allocating to Customers at the LE-BBO their portion of the original order.

5. The computerized trading platform as claimed in claim 3, wherein the small size order is 5 contracts.

6. A computerized trading platform, comprising:
a computer processor;
digital computer memory including computer code stored therein, the computer code controlling the computer processor to perform the steps of:
receiving an order for a transaction;
determining if a size of the order is at most a small size order;
allocating to a Lead Market Maker (LMM) all of the order as an Enhanced Allocation if the size of the order is at most the small size order (SSO) threshold and the LMM is quoting at a national best bid or offer (NBBO);
allocating to the LMM the Enhanced Allocation of the order if the size of the order is above the SSO threshold and the LMM is quoting at the NBBO, wherein the Enhanced Allocation is equal to the greater of (i) the SSO threshold, (ii) the proportion of the size of the quote of the LMM to the total quote size at the LE-BBO, (iii) sixty percent (60%) of the order if there is only one other Market Maker quotation at the LE-BBO, and (iv) forty percent (40%) of the order if there are at least two other Market Makers quotations at the LE-BBO.

7. The computerized trading platform as claimed in claim 6, wherein the small size order is 5 contracts.

8. The computerized trading platform as claimed in claim 6, wherein the order is a remaining portion of an original order after first allocating to Customers at the LE-BBO their portion of the original order.

9. The computerized trading platform as claimed in claim 8, wherein the small size order is 5 contracts.

10. The computerized trading platform as claimed in claim 6, wherein the order is an original order before first allocating to Customers at the LE-BBO their portion of the original order.

11. The computerized trading platform as claimed in claim 10, wherein the small size order is 5 contracts.

12. The computerized trading platform as claimed in claim 6, wherein the LMM is a Primary Lead Market Maker (PLMM) if the order was not Directed to a specific LMM or the order specified a Lead Market Maker other than the PLMM but the Lead Market Maker other than the PLMM was not quoting at the NBBO at the time the order was received.
